(19) United States
(12) Patent Application Publication
(10) Pub. No.: US 2004/0201738 A1
(43) Pub. Date: Oct. 14, 2004

(54) Method and apparatus for providing automatic access to images captured at diverse recreational venues

(75) Inventors: John Moores JR., Rancho Santa Fe, CA (US); Rob Zeps, San Diego, CA (US); Nashina Asaria, San Diego, CA (US); Kurt Kremer, Cardiff, CA (US); Pertti Visuri, Fallbrook, CA (US); Bryan Cokeley, San Diego, CA (US); Todd Makie, Carlsbad, CA (US)

Correspondence Address: BROBECK, PHLEGER & HARRISON LLP, 12390 EL CAMINO REAL, SAN DIEGO, CA, 92130, US

(73) Assignee: Tabula Rasa, Inc.

(21) Appl. No.: 09/993,023

(22) Filed: Nov. 13, 2001

(51) Int. Cl. H04N 5/232; H04N 5/228

(52) U.S. Cl. 348/231.2

(57) ABSTRACT

Digital cameras are arranged at points of interest in a recreational venue to automatically photograph individuals participating in activities at such points in response to detection of identifying parameters uniquely to corresponding to respective individuals, such as respective radio frequency identification (RFID) tag code. The photographs are automatically transmitted for storage in a database from which they may be accessed for viewing or printing upon presentation and recognition of the identifying parameter.

### BACKGROUND

1. Field of Invention

The subject invention relates to methods and apparatus for providing individuals with access to images of them captured at various venues including, for example, ski resorts, amusement parks, cruise ships, casinos and the like.

2. Description of Related Art

One service which has found acceptance at various recreational venues is the provision of facilities which permit participants in activities at a particular venue to obtain photographs of themselves participating in a particular activity. Examples of such services include photographers provided at ski areas to photograph skiers, as well as cameras positioned in theme parks to capture photographs of visitors as they ride a particular park attraction. To date, handling and distribution of copies of the resultant photographs has taken place by relatively rudimentary and cumbersome mechanisms.

### SUMMARY

According to one aspect of the invention images of individuals captured at various venues are associated with unique identifiers and stored in a database from which they may be accessed in response to presentation of the appropriate identifier. According to another feature, automatic recognition of a particular identifier is used to trigger an image capture device to capture an image of an individual, which image is then associated with, and accessible by presentation of, that unique identifier. According to another feature, a group of captured images and a group of corresponding identifiers are automatically transmitted over a wireless medium for storage in the database. In various recreational environments, use of one or more additional triggering events, such as breaking of an infrared beam by a downhill skier, is used to trigger the image capture device, e.g., a digital camera, after the image capture device has been enabled or initialized by automatic detection of the individual's unique identifier. In various embodiments, the identifiers may comprise RFID tag codes, biometric characteristics, bar codes, magnetic strips, etc.

### BRIEF DESCRIPTION OF THE DRAWINGS

Illustrative embodiments implementing the invention will now be described in conjunction with the accompanying drawings of which:

FIG. 1 is a high-level system diagram illustrating overall arrangement of apparatus for implementing various embodiments of the invention.

FIG. 2 is a schematic diagram illustrating general disposition of apparatus in connection with a ski area gondola embodiment.

FIG. 3 is a flow chart illustrating operation of the apparatus of FIG. 3.

FIG. 4 is a detailed schematic system diagram useful in illustrating methods and apparatus according to the invention.

FIG. 5 is a flowchart useful in illustrating operation of the system of FIG. 4.

FIG. 6 is a detailed system diagram of an alternative to the system of FIG. 4.

FIG. 7 is a schematic system diagram of a ski run embodiment.

FIG. 8 is a flow diagram useful in illustrating operation of the embodiment of FIG. 7.

FIG. 9 is a schematic system diagram of a ski area chair lift embodiment.

FIG. 10 is a flow diagram illustrating operation of an alternate embodiment.

FIG. 11 is a flow diagram illustrating operation of an alternate embodiment.

FIG. 12 is a flow diagram illustrating operation of an alternate embodiment.

FIG. 13 is a flow diagram illustrating operation of an alternate embodiment.

### DETAILED DESCRIPTION OF ILLUSTRATIVE EMBODIMENTS

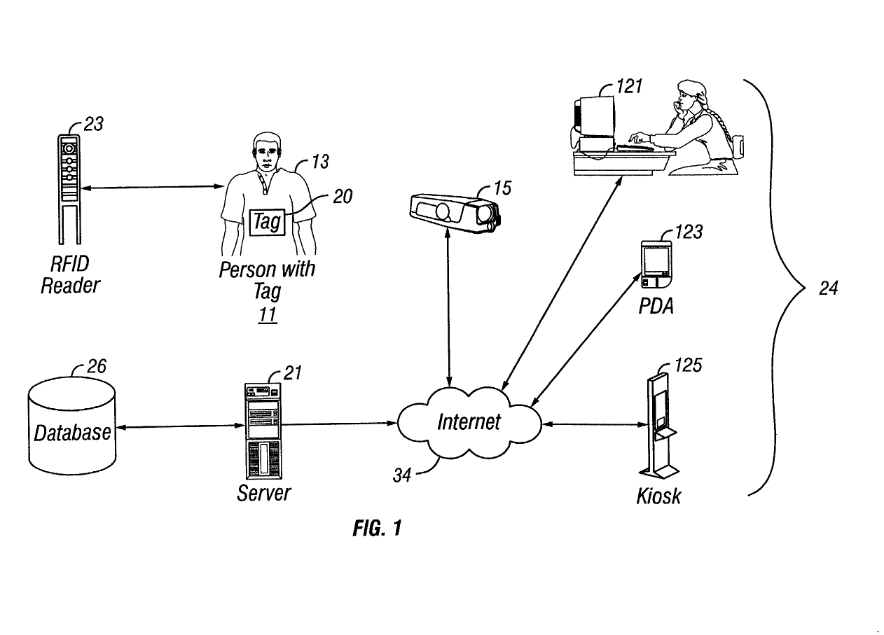

A general environment wherein methods and apparatus according to the invention may find application is illustrated in FIG. 1. As shown, an individual 13 in a recreational area 11 is fitted with a radio frequency identification (RFID) tag 20 carrying an identifier, e.g., a code uniquely identifying that individual 13. An image capture device 15, typically a digital camera or digital video camera is arranged at an appropriate location to photograph the individual 13. An RFID reader 23 is disposed to read the tag 20 tag at an appropriate time, typically just prior to activation of the image capture device 15 to capture an image of the individual 13.

The environment of FIG. 1 further includes a server 21 and an associated database 26. The server 21 and database 26 cooperate to store an image of the individual 13 in a file uniquely associated with the code carried by that individual's RFID tag 20. The server 21 typically receives the image and tag data via a communication medium 34, which may comprise wireless and hardwired communication links, as well as the Internet, and/or combinations thereof.

Finally, the environment of FIG. 1 includes a number of access points 24 at which the individual may subsequently access his or her image as stored in the database 26. Such access points include a conventional home computer 121; a portable personal digital assistant (PDA) device 123, and/or a Kiosk 125 where, for example, images can be reviewed or hard copy prints of the image made.

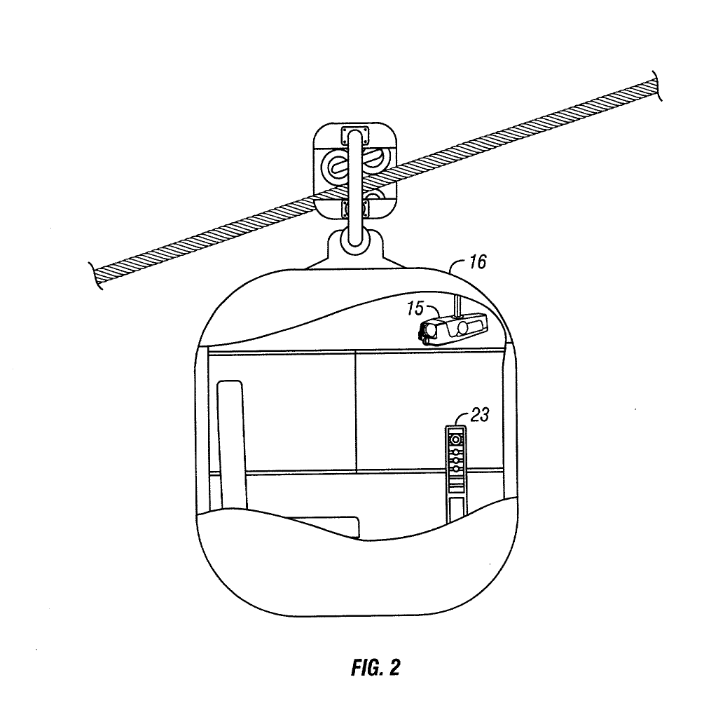

A particular example of implementation of the method and apparatus illustrated in FIG. 1 will now be discussed in connection with FIG. 2, which depicts a ski area environment. In this environment a conventional gondola car 16 is fitted with a digital camera or camcorder 15, as well as an RFID scanner 23 positioned to detect RFID tags 20 carried by individual skiers as they enter the car 16. The tags 20 carried by the skiers may form part of the skier's lift ticket, if desired.

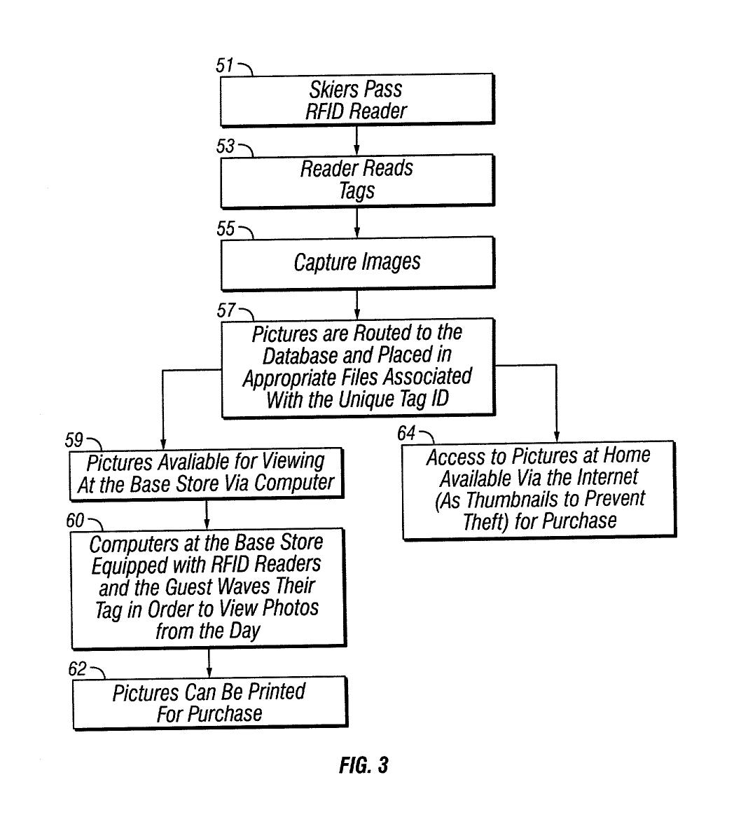

Operation of the system of FIG. 2 is illustrated in the flow diagram of FIG. 3. In the first step 51, the skiers pass the RFID reader 23 as they enter the gondola car 16. Next, in step 53, the RFID reader 23 reads the tag(s) carried by the respective skiers. Reading the first tag triggers the camera 15 to begin capturing a sequence of images of the individuals within its field of view, as illustrated in step 55. The field of view can be selected; for example, to capture images of persons seated in a particular seating area, thus enabling skiers to pose together, if desired. A button or switch may also be provided so that reading of the RFID tags prepares the camera 15 to take a picture and skier-activation of the button or switch actually triggers the camera 15 to begin taking pictures. Thus, the RFID tag detection and switch activation are logically “AND'd” to trigger the camera 15 to begin capturing images.

In step 57, the captured images together with the associated identifiers derived from the RFID tags 20 are sent to the server 21, which stores them in the database 26 in such a manner that the appropriate images can be retrieved in response to provision to the server, of the corresponding identifier or identifiers. In an illustrative embodiment, the identifiers are arranged to serve as an index to the images. As indicated at blocks 59, 61, 63, 65, the images are made accessible at home via the Internet or at a base store for viewing or printing in response to detection of an RFID tag presented by a skier who appears in the image.

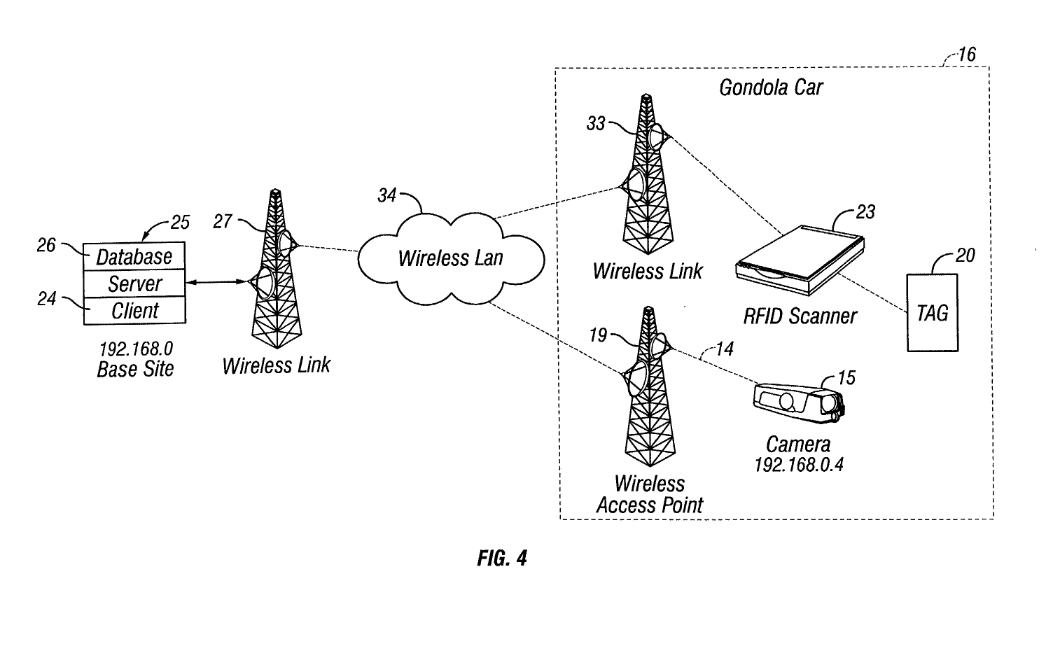

FIG. 4 more particularly illustrates apparatus for embodying the system and methods illustrated in connection with FIGS. 2 and 3. Various modifications and implementations of the methods and apparatus residing in the system of FIG. 4 may, of course, be made without departing from the scope and spirit of the invention.

In FIG. 4, a remote frequency identification (RFID) scanner 23 is shown mounted in the gondola car 16. The RFID scanner 23 communicates with a computer 25, via a wireless link 33, wireless LAN 34 and a wireless link 27. As noted above, the scanner 23 is a machine arranged to read information regarding an individual, in this case a skier, which information is encoded on a RFID tag 20 carried by the skier.

The apparatus of FIG. 4 further includes an image capture device 15 mounted in the gondola car 16 and communicating with a wireless access point 19. The wireless access point 19 is a location for an antenna, receiver or other device for transmitting or receiving a wireless transmission. The LAN of FIG. 4 therefore comprises the links 27, 33 and the access point 19.

In an illustrative implementation of the system of FIGS. 4, the 802.11b wireless technology is employed. As those skilled in the art will appreciate, 802.11b is a wireless Internet standard that operates in the 2.4 GHz band and can provide a nominal throughout of 11 Mbps (mega bits per second).

In the illustrative implementation, the RFID scanner 23 transmits events over a communication link to a client application 24 running on the computer 25 which employs, for example, the Windows 2000 operating system. The computer 25 hosts a database 26 and is further equipped with an 802.11 PCMCIA card to implement the first wireless link 27.

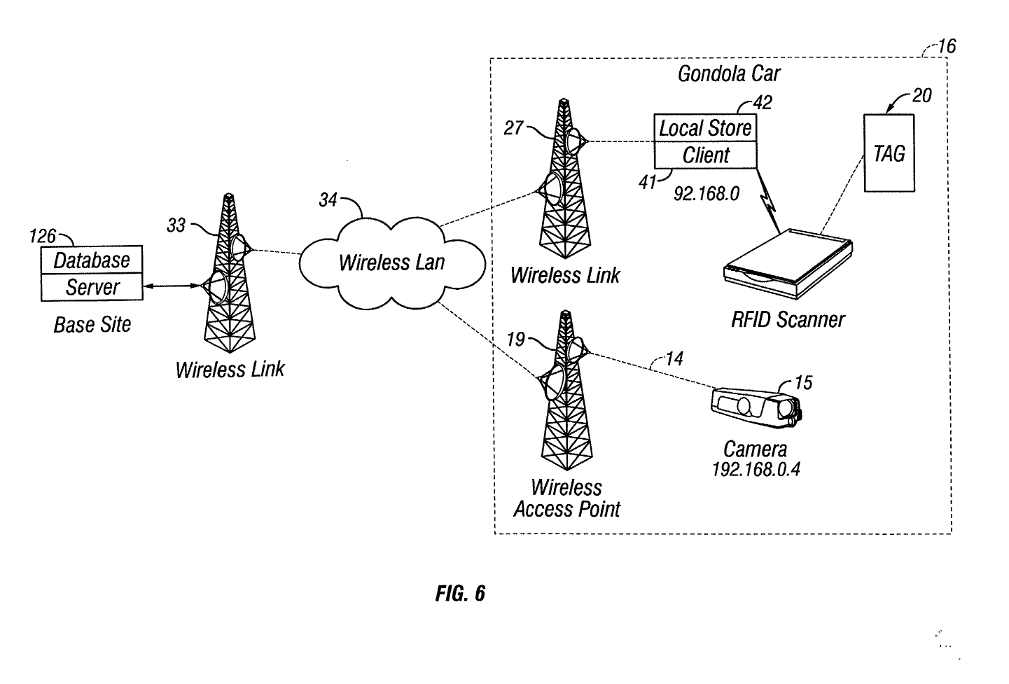

In the illustrative implementation, the computer 25 operates as a server and also hosts a client application 24, which interacts with the RFID scanner 23 as described hereafter in more detail. In other embodiments, such as that of FIG. 6, the client application 24 may run on a separate programmed digital computer arranged to communicate with the scanner 23. This second computer may then be arranged to handle communications over a wireless link between the client application and the server application.

Since the data processing apparatus represented by the computer 25 typically hosts the server, it is, at times, referenced hereafter simply as the server 25. As those skilled in the art will appreciate, numerous forms of data processing apparatus using various operating systems can serve the purpose of computer 25. The server 125 may, of course, comprise various combinations of computer hardware, such as a personal computer (P) with a self-contained database or other computer apparatus interfacing with an external or discrete database component.

The image capture device 15 employed in an illustrative implementation of the embodiment of FIG. 2 may comprise a digital video camera equipped with an Ethernet LAN card. The device 15 may, of course, comprise other image capture devices, including such devices which capture an image in pixilated form employing CCD or CMOS device technology. The access point 19 may comprise an Aironet 340 access point as available from Cisco Systems, San Jose, Calif., or other suitable component.

As illustrated in FIG. 4, the camera 15 and server 25 each preferably have a unique address and, in particular, an Internet Protocol (IP) address selected to facilitate wireless web-based or Internet communications. The illustrative implementation of FIG. 4 employs XML and HTML over the HTTP protocol. As indicated, the 802.11 protocol is used for all wireless communications.

The RFID tag 20 includes an identifier comprising information which uniquely identifies a particular individual and distinguishes each particular individual from each other individual involved. In the illustrative implementations under discussion, the identifier simply comprises a number or a numeric code which is uniquely associated with that individual.

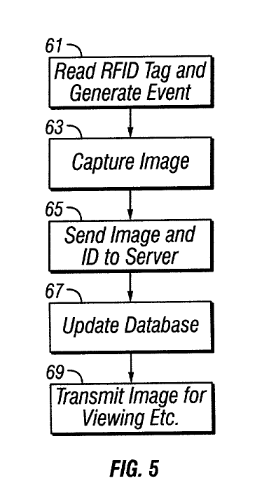

Operation of the illustrative implementation of the system of FIG. 4 will now be discussed in connection with FIG. 5. According to step 61 of FIG. 5, the scanner 23 reads the RFID tag 20 and generates a RFID Tag Event. No more than one such event may be triggered within a selected time period in order to avoid false triggers which might be generated as a result of the scanner 23 continuing to read the same tag 20. This mechanism to avoid false triggers is preferably incorporated into the RFID reader 23.

In response to generation of a RFID Tag Event, the client application causes transmission of a signal via the wireless link 27 to the camera 15. As indicated in step 63, this signal causes the camera 15 to capture an image or series of images of the field of view, typically including the individual who is wearing the RFID tag 20. The operation of camera 15 is initiated remotely over the wireless link by the client application via an HTTP request to capture and upload the appropriate image.

As indicated in step 65 of FIG. 5, the captured image and the corresponding identification number which has been read off the RFID tag 20 are then sent by the client application to the server application. The database 26 is then updated with the event id. (Step 67) This event id is thereafter used to locate the file where the image is stored.

With respect to program design considerations, the overall design may comprise an event flow model with events being generated by the RFID Reader 23, being processed by the client, and then the associated information being sent to a datastore which updates files/database records with the associated information.

Thus, each RFID tag 20 carries a unique identifying number, and each captured image is associated with the corresponding RFID number read off the tag 20. The RFID number is an index to a record stored in the database 26 for the particular individual whose picture was taken. As noted above, the RFID number may then be used later by the individual to access the photograph(s) at facilities such as illustrated in FIG. 1, e.g., a home computer 121, a Kiosk 125 or a PDA 123.

Additional capabilities may be provided in a system like that of FIG. 4. For example, the system may include the capability to collect statistics on RFID tags and images. Report specifications are defined for the number of tags read, invalid id number entries in the database, number of images recorded, etc.

Another capability which may be provided is the ability to administer the database records in order to add/update database information. Accordingly, import and export capabilities can be provided to interact with the database 26. An editor may also be provided to make minor changes to a given record. Mass import and export capabilities can be implemented using either Microsoft Excel or Access.

As those skilled in the art will appreciate, there are a wide variety of presently available RFID scanner/tag systems. While a RFID scanner-RFID tag system is preferred, other systems for detecting the individuals may be employed such as biometrics or other forms of machine-readable encoded tags such as, for example, Bar Code, Biometric or magnetic strip technology. An illustrative biometric approach is provided in copending U.S. patent application Ser. No. ______, filed on even date herewith and entitled Method And Apparatus Facilitating Personal Attention Via Wireless Networks, which is a continuation in part of U.S. application Ser. No. 09//955,535, filed, Sep. 12, 2001, both incorporated by reference herein. The just referenced U.S. Application also describes advantageous use of microbatteries incorporated as part of an RFID tag.

In the alternate embodiment of FIG. 6, the client application 24 runs on a separate computer 41 located in the gondola car 16. In such case, the scanner 16 can be connected to the client computer 41 by a hard wire connection, such as a RS232 interface. In FIG. 6, the digital camera 15 is shown as continuing to communicate via a wireless link 19 with the client 41 and a database server 126 at the base site. Thus, control signals are provided by the client 24 to the camera 15, while images captured by the camera 15 are downloaded to the server 25 directly through the wireless links 27, 33.

In another embodiment employing the apparatus of FIG. 6, the client 41 is arranged to initially receive the images captured by the camera 15, for example, over a direct hardwire connection to the camera 15 or via the wireless links as illustrated in FIG. 6. As in FIG. 4, the client 41 stores the images in a local database or image store 42 and associates them with the appropriate RFID tag identifier(s). The client 41 then downloads the images and associated identifiers to the database server 126 in response to a request transmitted via the LAN 34 to the client computer 42. This arrangement may prove advantageous in a system involving multiple cameras located at many locations around a ski resort or other venue since it permits the server 126 to control downloading of the images so as to avoid interference which may arise from multiple cameras attempting to transmit images at the same time to the base site. Each image is preferably time stamped and appropriately coded to indicate at which location, and by which camera, each image was captured.

Another advantage of the embodiment of FIG. 6 is that the on-board computer 42 can be programmed to play audio clips to coordinate the taking of the photograph—e.g., “please take a seat as I am about to take your photo,” followed by “Ok, smile and look at the camera,” followed by triggering of the photo taking session either automatically or in response to activation of a button or switch. Also, if a number of individuals enter the Gondola car 16, the client 42 can readily be programmed to associate one or a series of captured images with each of their respective RFID identification numbers. Additionally, a display screen can be provided so that the individuals can view their pose prior to their picture being taken.

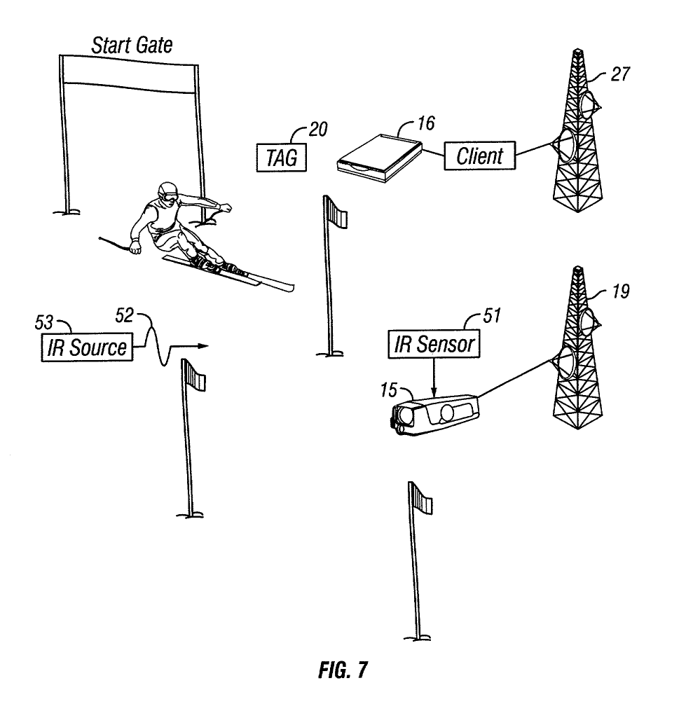

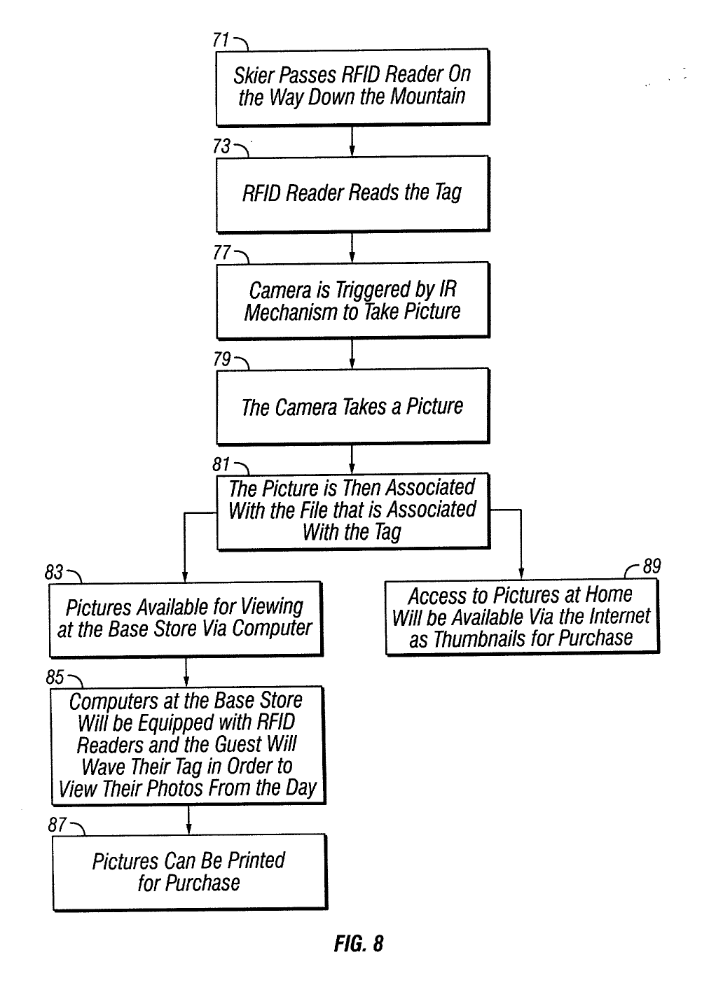

Another ski area application is illustrated in FIG. 7 where a RFID scanner 16 is arranged at the top of a slope, while an image capture device 15 is positioned downhill of the scanner 16. An infrared sensor 51 is arranged to detect a skier breaking an infrared light beam 52 provided by an infrared source 53. In this embodiment, the camera 15 is enabled to capture an image or series of images by detection of a RFID tag carried by a skier, as shown in steps 71, 73 of FIG. 8. The camera 15 is then triggered to take a picture of the skier when the skier breaks the infrared beam or at a selected delay interval thereafter, as shown in step 77. The camera 15 may be arranged to capture a series of images of the skier as he traverses an interesting or challenging item of terrain such as slalom pole 54 or a mogul. Handling and storage of the captured images is then accomplished as discussed in connection with FIGS. 4-6. Captured images can even be made available for viewing on a PDA as the skier rides up the next lift.

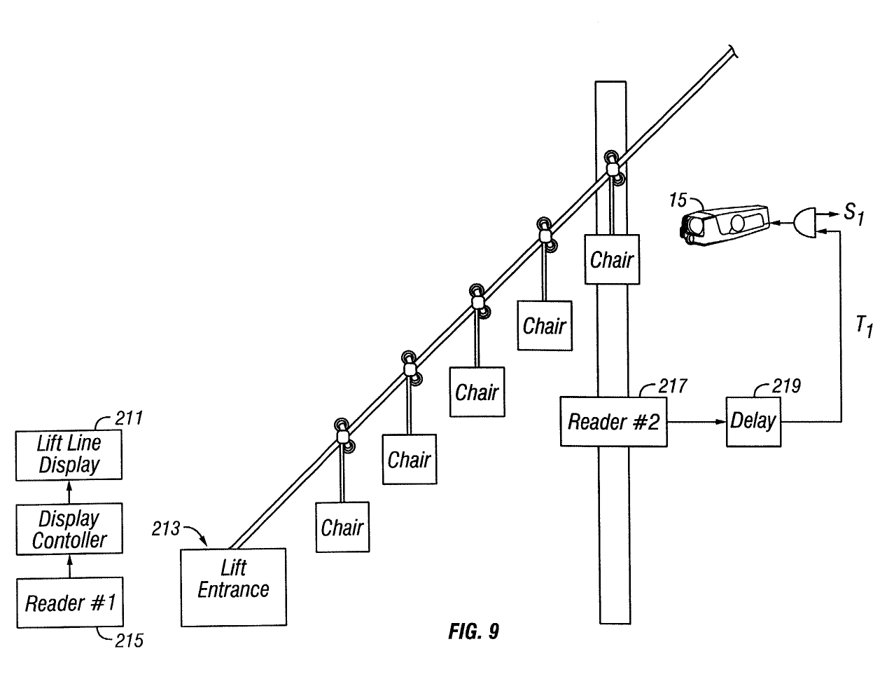

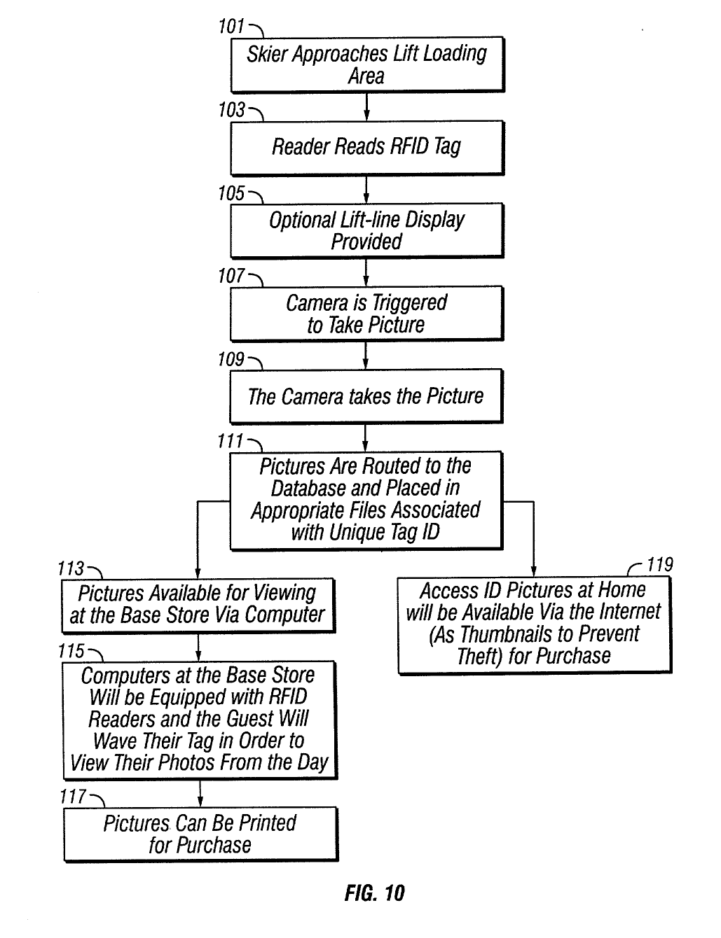

Another desirable ski area application is to capture images of skiers as they ride a chair of a chairlift. A process for capturing such images is shown in FIG. 10. The process may be achieved by systems employing various features disclosed in FIGS. 4 and 6 arranged as depicted in FIG. 9. A desirable feature provided according to FIG. 9 is a display 211 at or near the entrance 213 to the chairlift to display images selected to be of interest to people whose presence in the lift line has been detected by reading their RFID tag via reader 215.

In the environment of FIG. 9, the trigger mechanism is designed to account for the fact that chairlifts sometimes stop or slow and chairs are sometimes skipped. Thus, a second RFID reader 217 is positioned near the camera 15 and arranged to detect approach of the skiers to be photographed and to provide a second trigger signal T₂ to trigger actual image capture by the camera 15. The second trigger signal T₂, may be appropriately timed, if necessary, by a selected delay 219, which may be implemented by various means well-known in the art. Alternatively, a piezo electric sensor could be used to detect weight or strain and trigger an infra red beam, laser, or other light output which is then detected to trigger the camera 15.

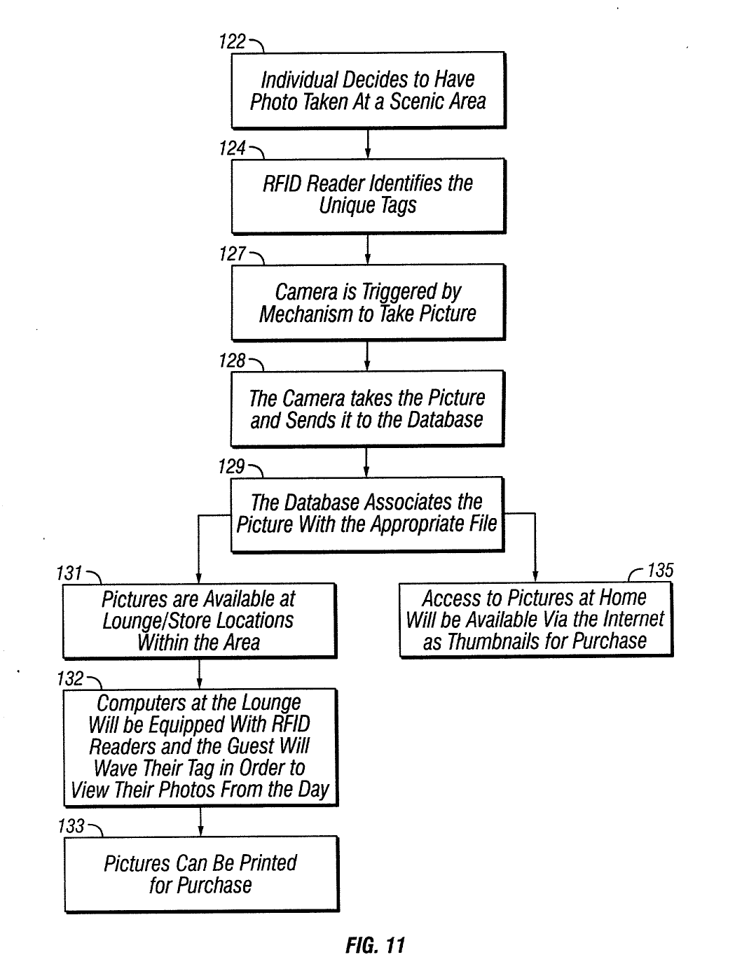

Systems and apparatus as disclosed in FIGS. 4-6 can also be readily configured to capture images at a scenic area, i.e., the rim of the Grand Canyon, and store them for later viewing, printing, etc. A process for capturing images at scenic areas is illustrated in connection with FIG. 11.

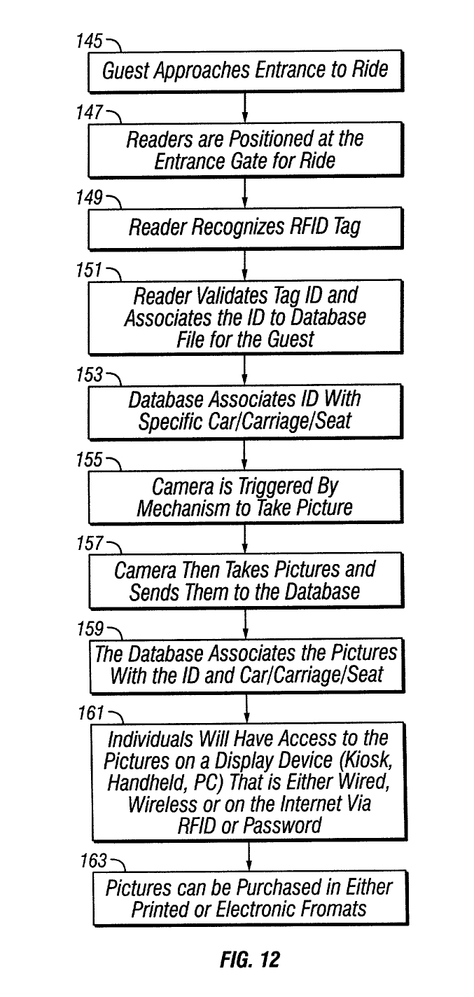

Another application which may employ apparatus as disclosed in FIGS. 4 and 6 is in capturing images of individuals as they ride amusement park or carnival rides. A process for capturing images in such an environment is illustrated in connection with FIG. 12.

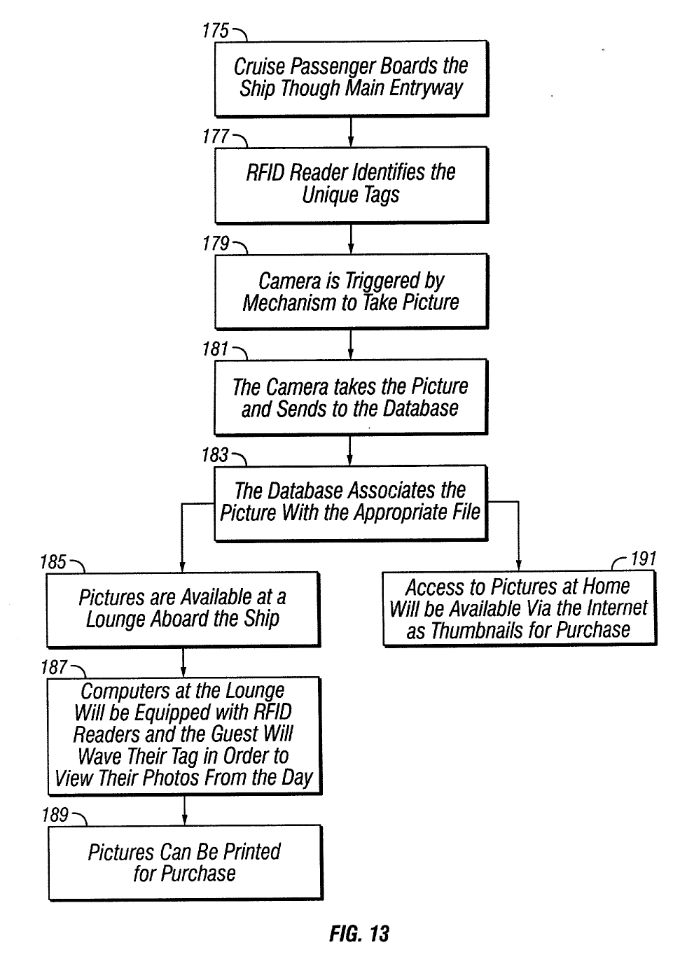

Another illustrative application of RFID image capture and storage systems is illustrated in FIG. 13, which particularly depicts a process applicable in a cruise ship environment.

While the present invention has been described above in terms of specific embodiments, it is to be understood that the invention is not limited to the disclosed embodiments. For example, while various wireless transmission links are disclosed above, they may be replaced in whole or in part by hard-wired communication links. Thus, the present invention is intended to cover various modifications and equivalent structures included within the spirit and scope of the appended claims.

What is claimed is:

1. The method comprising:
locating an image capture device at a venue of interest;
employing said image capture device to capture a plurality of images, each image including therein a likeness of a respective one of a plurality of individuals;
generating a plurality of identifiers, each identifier uniquely associating one of said individuals with each image which includes that individual's likeness; and
storing said images in a database located in such a manner that each image may be accessed through use of its corresponding identifier.

2. The method of claim 1 wherein each of said identifiers is also stored in said database.

3. The method of claim 1 wherein said identifiers are stored in said database in a manner which associates each said identifier with the image which includes the likeness of the individual corresponding to that identifier.

4. The method of claim further including the steps of:
automatically recognizing a selected identifier at the venue; and
automatically responding to the automatic recognition of a selected identifier to trigger said image capture device to capture an image, said image including a likeness of the individual associated with that selected identifier.

5. The method of claim 4 wherein generation of a second control signal is used in addition to said automatic recognition to control automatic triggering of said image capture device.

6. The method of claim 4 wherein each of said plurality of identifiers resides on a respective RFID tag carried by a respective individual and said automatic recognition comprises automatically reading a particular RFID tag.

7. The method of claim 5 wherein said second control signal comprises a signal generated using an infrared detector [the step of using an infrared light detection to generate said control signal], a motion detector, biometric detector, etc.

8. The method of claim 4 wherein each of said identifiers comprises a biometric feature and said automatic recognition includes the step of automatically recognizing said feature.

9. The method of claim 1 further including the step of transmitting said images via wireless transmission for storage in said database.

10. The method of claim 2 further including the step of transmitting said images and said identifiers by wireless transmission for storage by said database.

11. The method of claim 1 further including the step of making one of said images available for viewing at a viewing location in response to provision at the viewing location of an identifier corresponding to that image.

12. The method of claim 11 wherein said one of said images is made available by downloading it from said database to apparatus located at said viewing location.

13. The method of claim 12 wherein said apparatus comprises a computer display on which said image may be viewed after it is downloaded.

14. The method of claim 11 further including the step of enabling the making of a copy of said image or a portion thereof at said viewing location.

15. The method of claim 1 wherein a first identifier is recognized and one or more images captured corresponding to said first identifier, and wherein a second identifier is thereafter recognized and one or more images captured corresponding to that second identifier.

16. The method of claim 1 wherein the venue comprises a ski area.

17. The method of claim 1 wherein the venue comprises a theme park attraction.

18. The method of claim 1 wherein the venue comprises a cruise ship.

19. The method of claim 1 wherein the venue comprises a scenic attraction.

20. The apparatus comprising:
an image capture device located at a venue of interest and arranged to capture a plurality of images, each image including therein a likeness of a respective one of a plurality of individuals;
means for generating a plurality of identifiers, each identifier uniquely associating one of said individuals with each image which includes that individual's likeness; and
means for storing said images in a database in such a manner that each image may be accessed through use of its corresponding identifier.

21. The apparatus of claim 20 wherein each of said identifiers is also stored in said database.

22. The apparatus of claim 20 wherein said identifiers are stored in said database in a manner which associates each said identifier with the image which includes the likeness of the individual corresponding to that identifier.

23. The apparatus of claim 20 further including:
means for automatically recognizing a selected identifier at the venue; and
means for automatically responding to the automatic recognition of a selected identifier to trigger said image capture device to capture an image, said image including a likeness of the individual associated with that selected identifier.

24. The apparatus of claim 23 wherein said means for automatically responding is further responsive to a second control signal to control automatic triggering of said image capture device.

25. The apparatus of claim 23 wherein each of said plurality of identifiers resides on a respective RFID tag carried by a respective individual and said automatic recognition comprises automatically reading a particular RFID tag.

26. The apparatus of claim 24 wherein said second control signal comprises a signal generated by an infrared a motion detector, biometric detector, etc.

27. The apparatus of claim 23 wherein each of said identifiers comprises a biometric feature and said automatic recognition includes the step of automatically recognizing said feature.

28. The apparatus of claim 20 further including means for transmitting said images via wireless transmission for storage in said database.

29. The apparatus of claim 21 further including means for transmitting said images and said identifiers by wireless transmission for storage by said database.

30. The apparatus of claim 20 further including the means for making one of said images available for viewing at a viewing location in response to provision at the viewing location of the identifier corresponding to that image.

31. The apparatus of claim 30 wherein said one of said images is made available by downloading it from said database to apparatus located at said viewing location.

32. The apparatus of claim 31 wherein said apparatus comprises a computer display on which said image may be viewed after it is downloaded.

33. The apparatus of claim 30 further including means for reproducing said image or a portion thereof at said viewing location.

34. The apparatus of claim 1 wherein a first identifier is recognized and one or more images captured corresponding to said first identifier and wherein, a second identifier is then recognized and one or more images captured corresponding to that second identifier.

35. The apparatus of claim 20 wherein the venue comprises a ski area.

36. The apparatus of claim 20 wherein the venue comprises a them park.

37. The apparatus of claim 20 wherein the venue comprises a cruise ship.

38. The apparatus of claim 20 wherein the venue comprises a scenic attraction.
